(19) United States
(12) Patent Application Publication
(10) Pub. No.: US 2005/0038580 A1
(43) Pub. Date: Feb. 17, 2005

(54) Information about structural integrity of vehicles

(76) Inventors: Kerri Jean Seim, Grand Island, NE (US); Randy L. Gard, Grand Island, NE (US)

Correspondence Address: FISH & RICHARDSON PC, 225 FRANKLIN ST, BOSTON, MA, 02110, US

(21) Appl. No.: 10/641,893

(22) Filed: Aug. 15, 2003

(51) Int. Cl. G06F 19/00

(52) U.S. Cl. 701/29; 701/35

(57) ABSTRACT

In one aspect, data is maintained indicative of an aspect of structural integrity of identifiable vehicles after the vehicles have been manufactured, and selected portions of the data are distributed to customers in response to requests.

### BACKGROUND

This description relates to information about structural integrity of vehicles.

A frame of a vehicle, for example, is designed to have dimensions that conform closely (within specified tolerances) to predefined values that correspond to the original equipment manufacturer's (OEM's) specifications for the vehicle. Different models produced by different manufacturers have different specifications and tolerances.

Typically, the shape and size of a frame of a given vehicle can be considered to be within the manufacturer's specification if a relatively small number of key positions on the frame are at the locations intended by the specification or to within some predefined tolerances of those locations. The degree to which the frame shape and size meet the manufacturer's specification may be considered an aspect of the structural integrity of the vehicle. Other elements of a vehicle may also contribute to its structural integrity. And structural integrity may include characteristics other than shape and size, for example, whether the frame is severely rusted. All vehicles have frames.

When the structural integrity of a vehicle has been compromised, for example, if the frame is bent in an accident, the vehicle's value drops, in some cases to zero. In other cases, the vehicle can be repaired, for example, by straightening the frame until it again meets the specifications.

It is often impossible to determine merely by looking at a vehicle or its frame whether the frame is bent. Without knowing whether the frame complies with specifications, anyone interested in the value of the vehicle can only make assumptions that may prove wrong. Significant losses are associated with incorrectly estimating the values of vehicles because of incorrect or insufficient information about their structural integrity. These losses may be incurred by a wide variety of parties, including owners, lessors, buyers, sellers, agents, auctioneers, manufacturers, insurers, fleet owners, rental vehicle companies, new and used vehicle dealers, and others.

Vehicle dealers often provide certifications of used vehicles, but the dealers do not verify the structural integrity of a vehicle's frame. Visual frame inspections are sometimes done to support the frame portion of the certification. It is believed that at least 8% of the used vehicles that are certified do not meet frame specifications.

The frames of vehicles are often straightened by pulling them back into shape using special equipment, for example, the equipment sold by Chief Automotive Systems, Inc, of Grand Island, Nebr., under the name Excelerator. (Other manufacturers also supply pulling equipment.) Typically, in connection with straightening, the frame is measured at key positions and the variation of those measurements from specifications for the models is reported to the person who is operating the pulling equipment. Measuring equipment is available from several vendors. The Velocity, Vector, and other systems supplied by Chief Automotive includes targets that are hung from the key positions on the underside of the frame and a laser scanner that scans a beam onto the targets, senses light reflected from the targets, and generates signals indicative of the measurements of the key positions. The signals are then processed by a personal computer to determine the measurements of the key positions and the measurements are compared to the expected measurements of the specifications.

The specifications for a large proportion of existing vehicle models are provided and updated quarterly on the personal computer using CD-ROM disks that are circulated to shops that have pulling and measuring equipment. The personal computer displays diagrams of the frames of vehicles that are to be pulled showing the key positions. The actual measurements taken by the measuring system can be displayed on the diagram of the frame and printed, both before and after the pulling operation. The diagram can show the actual measurement and the specification value. The operator of the pulling machine can then satisfy himself that the frame has been pulled back into its intended shape. Additional information about the Velocity system, including user manuals, is available from Chief Automotive.

The manufacturer's intended specifications about vehicle models can be inferred by measuring the frames of new units of the vehicle models. The measurements can be made at key positions identified by the operator of the measuring equipment based on experience. The measurements of various models can be made at different locations around the world. As new models are produced by manufacturers, they can be measured to generate new specification information. The measurements are then accumulated in a central database of specification information from which the quarterly CDs can be produced.

In large shops, multiple sets of pulling equipment and measurement systems can be connected using a local area network. Measurement data can also be stored locally for later use.

Parties who are interested in information about specific vehicles for use in estimating their values can use online services such as the service provided by CarFax. CarFax maintains and makes available records of information for millions of vehicles identified by their Vehicle Identification Numbers (VINs). The available information may include title information, odometer information, known problems such as major accidents, and registration information.

Vehicles are commonly equipped with “black box” recorders that track and store information about incidents associated with airbag deployment, for example, vehicle speed, brake status, throttle position, and seat belt status. The data can be recovered later (called crash data retrieval), for example, after an accident.

### SUMMARY

In general, in one aspect, the invention features a method that includes maintaining data indicative of an aspect of structural integrity of identifiable vehicles after the vehicles have been manufactured, and distributing selected portions of the data to customers in response to requests.

Implementations of the invention may include one or more of the following features. The aspect of structural integrity includes frame straightness. The aspect of structural integrity includes involvement in collisions. The vehicles are identified by vehicle identification numbers. The requests of at least some of the customers are received through a website or email. Payment is arranged by the customers for the selected portions of the data. The data indicative of an aspect of structural integrity includes data that is acquired by inspection (e.g., measurement) of the vehicles. The data is acquired by measuring locations on the vehicle and comparing the measurements to predefined values. The data is maintained in a central database and distributed through a server.

In general, in another aspect, the invention features a method that includes associating first data indicative of an aspect of structural integrity of an identifiable vehicle as of a first time with second data indicative of the aspect of structural integrity of the identifiable vehicle as of a second time, and making the associated data available as a history of the aspect of structural integrity of the identifiable vehicle.

Implementations of the invention may include one or more of the following features. The history is distributed to a user in response to a request. The first data and second data indicative of an aspect of structural integrity include data that is acquired by inspection (e.g., measurement) of the vehicle. The first data and the second data is maintained in a central database and distributed by a server. Additional data of the aspect of structural integrity of the identifiable vehicle as of another time is associated with the first data and the second data as part of the history.

In general, in another aspect, the invention features a method that includes receiving data indicative of an aspect of structural integrity of identifiable vehicles after the vehicles have been manufactured, the data being generated by inspection of the vehicles at multiple locations.

Implementations of the invention may include one or more of the following features. The data is updated from time to time based on additional inspections of vehicles. At least some of the data is received from locations at which vehicles have been inspected. The aspect of structural integrity includes frame straightness. The aspect of structural integrity is associated with involvement in collisions. The vehicles are identified by vehicle identification numbers. Data for an identified vehicle is distributed to a customer in response to a request. The request of the customer is received through a website or email. The data is maintained in a database that associates vehicle identification numbers with received data for the corresponding vehicles. Data indicative of expected structural integrity of the vehicles based on information about original specifications for vehicles is sent to multiple locations

In general, in another aspect, the invention features a method that includes acquiring, by inspection, data indicative of aspects of structural integrity of a vehicle, and based on the data and information about an expected structural integrity of the vehicle, indicating one of either that it conforms to the expected structural integrity or that it does not conform to the expected structural integrity.

Implementations of the invention may include one or more of the following features. The data and information are maintained at the location where the vehicle is inspected.

In general, in another aspect, the invention features a method that includes providing to a user upon request a confirmation of whether or not an aspect of structural integrity of an identifiable vehicle complies with an expected structural integrity of the vehicle.

Implementations of the invention may include one or more of the following features. The confirmation is based on data that is acquired by inspection of the vehicle. The confirmation is provided through a website or by email. The confirmation is based on comparison with predefined values for structural integrity.

In general, in another aspect, the invention features a method that includes maintaining a central database that associates each of a set of vehicle identification numbers of vehicles with data indicative of an aspect of structural integrity of the vehicle, the data being derived from at least one inspection of the vehicle, the inspections of at least some of the different vehicles having been done at different locations.

In general, in another aspect, the invention features a method that includes acquiring data indicative of an aspect of structural integrity of a vehicle at an inspection facility, and communicating the data from a local device associated with the inspection facility to a central database that includes structural integrity data for other vehicles acquired at other inspection facilities.

In general, in another aspect, the invention features a method that includes acquiring data indicative of an aspect of structural integrity of vehicles at an inspection facility, communicating the data from a local device associated with the inspection facility to a central database, maintaining a copy of a portion of the central database on the local device, and synchronizing the portion of the database on the local device with the central database.

Implementations of the invention may include one or more of the following features. The synchronizing includes communicating to the central database information about vehicles that has been acquired at the local device and not previously communicated to the central database. The synchronizing includes communicating to the local device information about vehicles that has been acquired otherwise than at the local device.

In general, in another aspect, the invention features a method that includes communicating electronically from a database to an intermediary, for redistribution to users, data that associates vehicle identification numbers of vehicles with data indicative of structural integrity of the vehicles, and providing updates of the data automatically.

Implementations of the invention may include one or more of the following features. The intermediary includes an on-line information provider. The updates are communicated as a continuous stream that contains data not previously communicated. The updates are communicated as a batch that contains data not previously communicated. Payment is received for the updates.

In general, in another aspect, the invention features a method that includes communicating electronically from a database to a party, for use in making a decision about a vehicle, data that associated vehicle identification numbers of vehicles with measured data indicative of structural integrity of the vehicles.

Implementations of the invention may include one or more of the following features. The data is communicated to an individual and the decision includes whether to buy the vehicle. The data is communicated to an insurance company and the decision includes whether to pay a claim for damages to the vehicle. The data is communicated to a financing entity and the decision includes whether to lend money secured by the vehicle. The aspect of structural integrity includes the extent to which the frame matches its original condition.

In general, in another aspect, the invention features a method that includes making available to a user of a website, information about vehicles that are identified by vehicle identification numbers, and enabling the user to access structural integrity information for a vehicle selected by vehicle identification number.

Implementations of the invention may include one or more of the following features. Other kinds of information about the vehicles are made available to the user on the website. The other kinds of information include collision reports for the vehicles. Payment is arranged by the customers for access to the information.

In general, in another aspect, the invention features a method that includes enabling a user to set up equipment to acquire data indicative of an aspect of structural integrity of a vehicle, and providing voiced machine prompts to guide the user in correctly setting up the equipment.

Implementations of the invention may include one or more of the following features. The voiced machine prompts identify locations to be measured on the vehicle. The voiced machine prompts confirm whether the locations have been correctly set. The voiced machine prompts are provided from a device that also controls acquisition of the data by the equipment. The aspect of structural integrity of the vehicle includes occurrence of a collision.

In general, in another aspect, the invention features a method that includes analyzing original equipment manufacturer's engineering drawings with respect to an aspect of structural integrity of a vehicle, and generating a specification for locations at which to measure the aspect of structural integrity for an actual vehicle built according to the engineering drawings.

Implementations of the invention may include one or more of the following features. The locations are locations on a frame of the vehicle.

In general, in another aspect, the invention features a method that includes analyzing data indicative of an aspect of structural integrity of vehicles manufactured by a particular manufacturer, and identifying possible flaws in vehicle design based on results of the analysis.

Implementations of the invention may include one or more of the following features. The data is associated with units of a vehicle of a particular model. The data is derived by inspection of the vehicles after they have been manufactured and placed into use. The flaws are made available to manufacturers. The aspect of structural integrity includes frame straightness.

A database including a set of vehicle identifiers, and associated with each of the vehicle identifiers, data indicative of an aspect of structural integrity of the vehicle.

Implementations of the invention may include one or more of the following features. The vehicle identifiers include vehicle identification numbers. The data indicative of an aspect of structural integrity of the vehicle includes data acquired by measuring locations on the vehicle. The database includes data indicative of expected structural integrity of the vehicle based on information of the manufacturer of the vehicle. The data includes frame straightness data. The data includes collision data.

In general, in another aspect, the invention features a method that includes receiving frame straightness data from multiple locations at a central database, the frame straightness data having been produced by inspecting automobiles for frame straightness at the multiple locations, including in the central database information related to comparisons of the straightness data with reference straightness information derived from manufacturers of the automobiles, providing the straightness data or the comparison information to users upon request, and receiving payment from the users for the data or information.

In general, in another aspect, the invention features apparatus that includes a port to receive structural integrity data from an inspection device that inspects an automobile for structural integrity, and a processing device configured to communicate the structural integrity data to a location in which a central database of structural integrity information and related vehicle identification information is maintained.

Implementations of the invention may include one or more of the following features. The apparatus includes a user interface that is associated with the processing device and enables a user to control the inspection device. The apparatus includes a voice synthesizer to provide voice instructions to the user for setting up and using the inspection device. A storage device to holds information about expected structural integrities of models of vehicles, and the processing device is also configured to compare the inspected structural integrity information to the expected structural integrity information.

In general, in another aspect, the invention features a machine-based method that includes (a) receiving from a data recorder associated with a vehicle, data obtained at the time of an occurrence of an incident that may have altered a structural integrity of the vehicle, (b) after the incident, receiving measurements of the structural integrity of the vehicle, and (c) analyzing a relationship between the incident data and the measurements.

Implementations of the invention may include one or more of the following features. The incident data includes at least one of vehicle speed, engine RPM, and brake application, throttle position, seatbelt state, airbag state, airbag warning light state, time from impact to airbag deployment, and maximum change in velocity for a near deployment incident. The incident comprises an accident. The measurements include measurements of a frame of the vehicle. Incident data and structural integrity measurements are obtained for multiple vehicles and multiple incidents, and the data and structural integrity measurements are statistically analyzed. The data recorder comprises a recorder associated with an air-bag system. In general, in another aspect, the invention features, a verification inspection workstation comprising a housing, a laser scanner, targets, attachments, a computer, a monitor, and software configured to enable the computer to acquire measured information about the structural integrity of a vehicle and to forward the information electronically to a central server at which information about the structural integrity of other vehicles is stored.

In general, in another aspect, the invention features a server that includes a computer, and software configured to enable the computer to maintain measured information, acquired at multiple remote locations, about the structural integrity of vehicles and to distribute the information to users upon request.

Among the advantages of the invention are one or more of the following.

The verification system provides proof that the frame is within tolerances of its original shape specifications and prints documentation of the proof. As a result of providing this proof, dealers can raise the resale value of verified vehicles, increasing their revenue and margins. Dealers also take a certain amount of risk when accepting a trade-in vehicle. The verification system helps to eliminate that risk by giving the dealer proof of what they are purchasing and eliminating their diminished value liability. Through finding vehicles that fail, dealers can also direct business to their collision and parts departments, as these vehicles will require repair.

Independent used vehicle dealers have the added value of increasing resale pricing and providing true certified vehicles to their clients, a new option in this market. They also obtain a competitive advantage against other independent dealers and some OEM dealers.

Auto auctions provide inspection services to OEM's and are obligated to provide credibility to the vehicles they auction. If a client purchases an auction vehicle and finds frame damage, the auction may have to go through legal arbitration and will have to buy back the vehicle. The verification system provides auctions protection against such costs.

Fleet operators who have to remarket vehicles need to maintain the vehicles in a safe condition. The verification system gives them a way to ensure the safety of their fleet and to attain high resale values. The same considerations apply to vehicle rental companies.

Other features and advantages of the invention will be apparent from the description and from the claims.

### DESCRIPTION OF DRAWINGS

FIG. 1 is a three-dimensional view of an inspection station.

FIGS. 2-4, 5A, and 5B are block diagrams.

FIGS. 6A to 6R are annotated user interface images.

FIGS. 7 and 8 are examples of inspection reports.

### DESCRIPTION

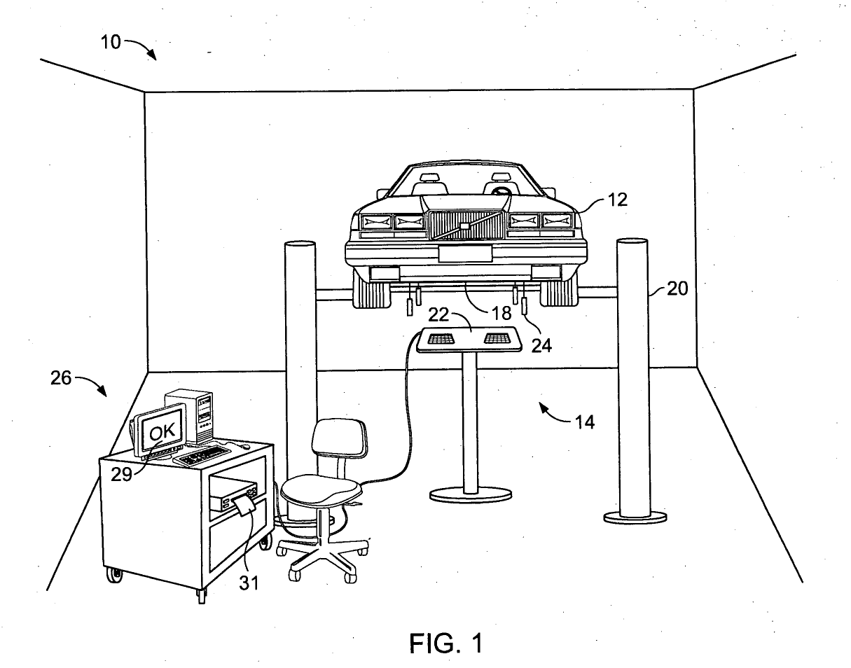

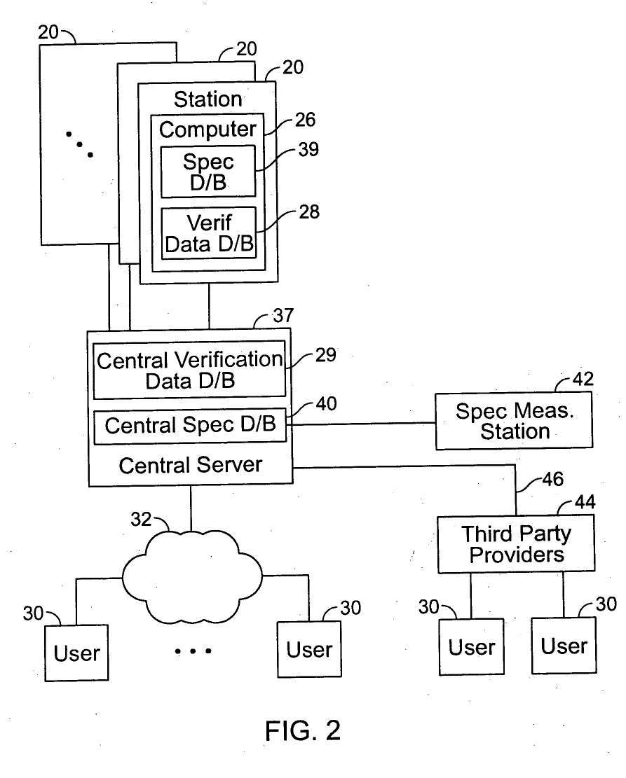

As shown in FIG. 1, a computerized verification system 10 can be used to verify the structural integrity of a vehicle 12, in particular, of the frame 18 of the vehicle. Measurements needed by the verification system can be derived by a frame measurement system 14, such as Chief Automotive's Velocity measuring technology, or other measuring or verification system. Using vehicle measurements that are based on OEM specifications, the verification system verifies whether the frame 18 is within predetermined tolerances of the OEM specifications. (OEM specifications do not necessarily mean specifications that are written as such and made available the OEM, although they could include such specifications. OEM specifications may also be implied by formal mechanical drawings. They may also be implied by the actual shape and size of original frames in new vehicles manufactured by the OEM.) To take the measurements, the vehicle is mounted on a two-post lift 20, a two or four-laser scanner or photo/sound/light measurement device 22 is placed on a tripod in the center of the vehicle, and targets 24 are hung from predetermined points on the vehicle frame. The laser beams reflect off the targets back to the scanner and information is transmitted to a computer 26. The computer triangulates the known data of the laser points with the return data from the targets to determine the measurements in three-dimensions of the key positions at which the targets are placed. If the measurements are within the predefined tolerances of the specification for the key positions, the computer will display 29 and print an indication that the vehicle's structural integrity is “OK”. Otherwise, the computer will display and print the position measurements. A printed report 31 (including the pass-fail indication) is generated and may be stored as a jpeg file for later use.

Tolerances are associated with measurements of the individual key positions, and on the symmetry of pairs of key positions (for example, at symmetrical locations on the left side and right side of the frame). The acceptable tolerances may be set by parties other than the OEMs. For example, for vehicles, industry standards have been developed by Manheim auctions and Chief Automotive and are set, for example, as 8 mm for a single key location, meaning that location must match the specification with a tolerance of plus or minus 8 mm, and as 6 mm symmetrical, meaning that the locations of two corresponding symmetrical points relative to specification must be within 6 mm of each other. The acceptable tolerances may be set by the manufacturer of the system or by the user as required for various markets.

The resulting pass-fail information may be useful to a wide variety of parties, including: OEM franchise dealers (for example, a local Ford dealer), independent used vehicle dealers, vehicle auctions, company-owned fleets, vehicle rental companies, independent inspection companies, and franchised inspection companies. The inspection companies would perform verifications for online information services, consumers, dealers, and auctions on a per vehicle fee basis. In general, the word inspection includes in many examples, the measurement of the frame of the vehicle and we sometimes use the word inspection to mean measurement.

Thus, the verification system and the resulting pass-fail certification are useful for particular parties engaged in a transaction involving the vehicle. For example, an auction operator may send a particular vehicle to an independent inspection company for certification of the structural integrity. The auction operator would use the resulting certification in connection with the sale to a used vehicle dealer or wholesaler.

The certification information (pass-fail, for example) or verification information (which could also include actual measurements and other information; we sometimes use the phrase verification information to refer to certification information alone) for a vehicle may also be stored at the computer for later re-use by the inspection company or by the auction operator or the ultimate customer. In addition, the verification information may be made available to other parties for a fee. By storing verification information of a large number of vehicles in a central database, it is also possible to provide a valuable service on CD-ROM or on-line or in print because the database would contain information useful to a large number of customers.

The verification information or (also called verification data) thus offers the possibility of a recurring revenue stream. The verification data collected by each local verification system is stored on the system and retrieved either on-the-fly or ahead of time into a central database from which it can enable future data sales during the full life cycle of each vehicle. The data could be made available as part of vehicle histories containing other information that is already available through government sources, independent inspection companies, and automotive service providers.

A wide variety of customers may use the comprehensive verification data, including used vehicle consumers, online information providers, such as CarFax and on-line vehicle sales companies. The verification data adds credibility and reliability to reports of online information providers. On-line sellers, such as E-Bay provide a market for interaction by buyers and sellers. Providing verification information to such sellers and their customers would be valuable.

Note that the verification system need not be and would typically not be used in the context of pulling a vehicle frame to correct its shape. Rather, the verification system is used in the context in which it is important to determine whether the frame shape complies with original manufacture frame condition dimensions and shape even though the correction of the frame, if any, is done at a different time and in a different context. Thus, frame verification is usually (but not always) a separate process that may be (and likely will be) done in locations and facilities that are dedicated to measurement and verification.

The frames of a large number of vehicles can be measured and compared to specifications at a large number of inspection stations 20 (like the one shown in FIG. 1, for example). The stations could be located anywhere in the world. Each station could be operated separately to do no other work than verifications. Or each station could be associated with other facilities, including repair shops and auction lanes, for example. Multiple stations could be located together. The verification data accumulated at each station from measurements of multiple vehicles are stored in a local database 28, indexed by vehicle identification numbers, VINs. The verification data accumulated at the different stations is uploaded to a central database 29 maintained on a central server 37.

As a result, a wide variety of millions of users and customers 30 located anywhere in the world can learn the integrity of the frame of any selected vehicle having a particular VIN, provided that the frame has been measured at least once at one of the stations. The users can get the verification information using a communication link 32 from the central server 37. The communication link could be the Internet, a dial-up line, email, or a variety of other communication media.

For use in comparing the measured frame data, the original manufacture frame condition dimensions are stored in the local station's computer in a specification database 39. The specifications in the local server 39 are kept current by downloading updated information from the central server over a communication link. The specification information may also be distributed on CD-ROM or paper in other examples. A central database 40 of specification stores current specification information for redistribution to the stations.

The new and updated specification information for vehicle models can be obtained from measurement stations 42 at which new units of the models are measured, in the manner described earlier. Alternatively, the specification information can be derived from drawings or numerical specification data generated by the OEMs. The drawings and numerical specification data may be analyzed manually to derive the locations of the key positions for measurement and the design measurements. Alternatively the information may be derived automatically from the figures or from the numerical specification data.

When a vehicle has been measured, the measured data is compared to the specification data, in light of predefined tolerances by software in the computer 26. The measured data and the result of the comparison are stored in the database 29. At the same time or at a later time, the verification information stored at each station is uploaded to the central server and stored in the central verification database. The uploading may be done automatically at periodic pre-set times or may be done manually by an operator at the server or by an operator at the local station. The uploading may occur without alerting the station operator or may be done only upon notification to and approval by the station operator.

Although users 30 may, as explained, have direct access to the central database of verification data, through communication link 32, (or through link 32 and link 45 to third-party provider 32) users may also have access indirectly through third-party information providers 44. Examples of such third-party providers include Internet portals such as Lycos or Yahoo, retail websites such as Amazon.com, automobile information providers such as CarFax, and a wide variety of other providers. The verification information may be provided as a separate product or service to customers of the provider, or it may be bundled with or embedded in other products, services, or information made available to the customers. To enable such providers to make the verification information available in various forms, a data feed 46 may be provided from the central server to the third-party provider. The data feed could be in the form of a continuous data stream, or a batch file of updates, or could be provided on CD-ROM or through other media. A fee could be charged for use of the data feed based on number of uses or frequency of updating or number of records.

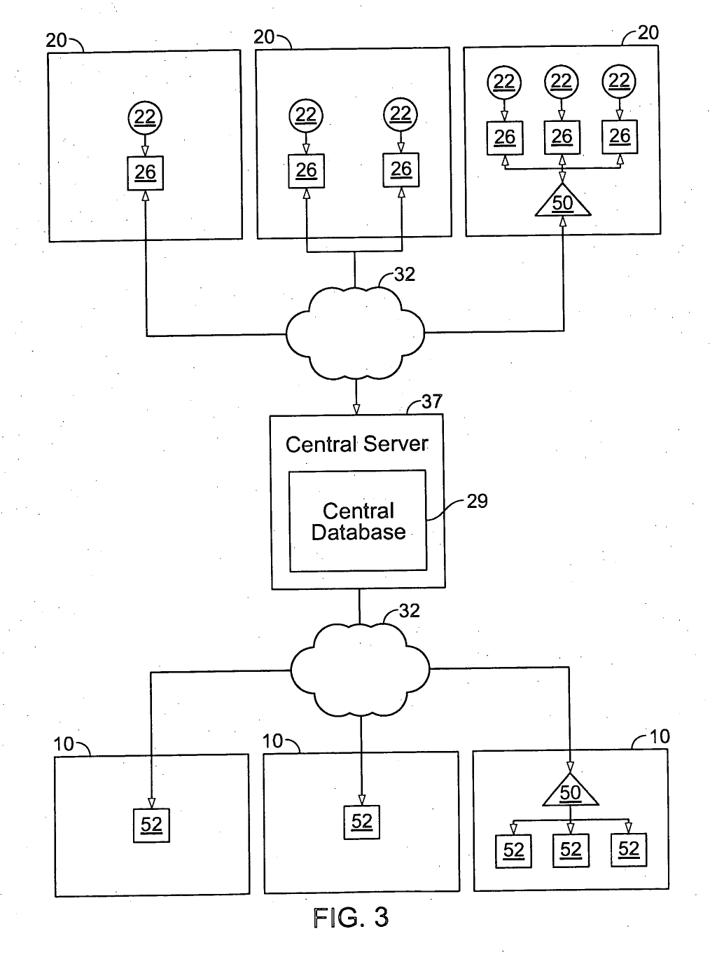

As shown in FIG. 3, a large number of stations 20 can provide frame verification data to the central server 37. Each of the stations 20 can include a single scanner 22 connected to a single local computer 26 or may have multiple scanners 22 connected to one or more local computers 26, all connected by a local area network 50. Users, on the other hand, may access the verification information using a single computer 52 or may have multiple computers 52 connected by a local area network 56.

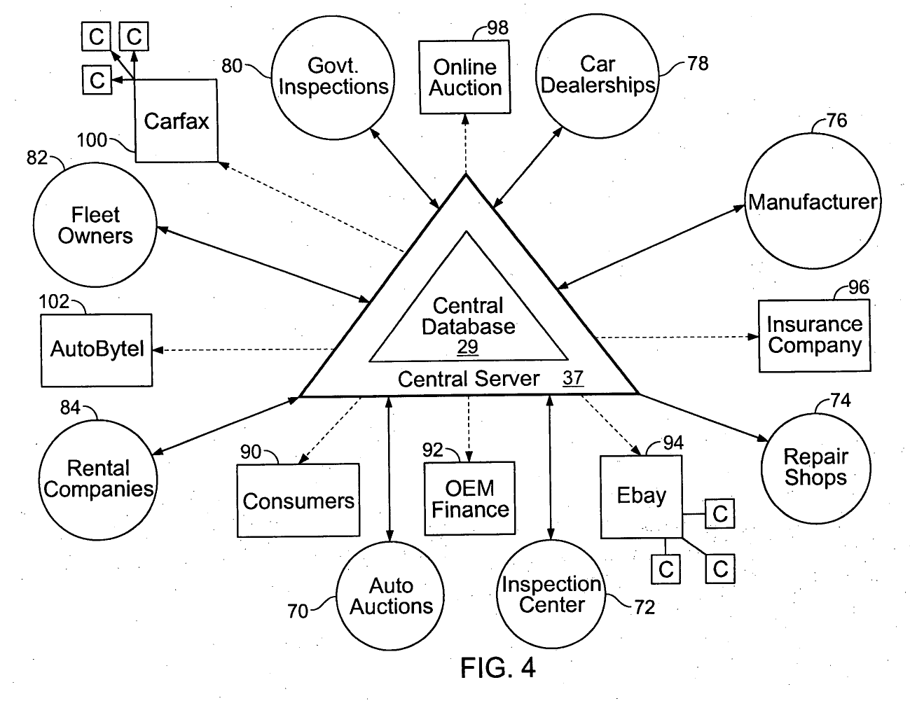

Thus, as shown in FIG. 4, a variety of different sources and users provide and receive verification information in central server 37. The sources could include vehicle auctions 70, independent and franchised vehicle inspection stations 72, repair shops 74, manufacturers 76 vehicle dealerships 78, government inspection facilities 80, fleet owners, and rental companies 82. The users could include all of those parties and also consumers 90, lenders, including OEM financers 92, on-line sellers, including eBay 94, insurance companies 96, online auctions 98, and information providers such as CarFax and AutoBytel 100, 102.

Users may use the system to determine the frame integrity of a vehicle having a particular VIN number or may use the system to obtain and then analyze large numbers of records of the verification information for many vehicles. The latter may include auto auctions, insurance companies, and finance companies. The statistical information derived from such data may enable these parties to reduce the cost of their products, reduce fraud, and increase profit margins.

A vehicle may undergo verification inspections more than once (e.g., many times) during its lifetime. Because each test can be associated with the vehicle's VIN, the central server can maintain a history of the inspections and their results. Having a history of inspections and verification information for a given vehicle can be useful in various ways. The verification information could be correlated with other historical information about the vehicle, including reported accidents, its age, and its registration history.

Verification information may also be correlated with information derived from a data recorder (also called a black box) that is mounted in the vehicle to record operating data for the vehicle that is associated with “incidents”, for example, an incident involving an accident. Information may be collected from the data recorder by equipment such as the Velocity alignment system available from Chief Automotive. In the Velocity system, the black box data is used in connection with aligning the wheels of a vehicle. If the vehicle has been involved in an accident, the recorder data may be useful in performing the wheel alignment effectively. In connection with a verification inspection, the recorder data could be obtained using the Velocity equipment and communicated to the verification system for storage with the verification information. Or a black box reader could be incorporated directly into the verification equipment so that recorder data could be obtained directly at the same time as the verification inspection is being performed. The recorder data would then be stored as part of the verification information on the local computer and uploaded to the central server to become part of the verification information database. The recorder data could then also be provided to users directly and indirectly through online information providers. In addition, statistical analyses could be performed on the recorder data and the corresponding verification information to study the correlation between vehicle operating parameters that are associated with an accident and the effect on the shape of the frame at the key positions. Such studies could enable improved designs of frames and vehicles.

More generally, and even without access to the recorder information, the verification information for vehicles can be statistically analyzed to identify vehicle design flaws by model or manufacturer. The availability of large numbers of verification inspection records for units of a given model make such statistical analysis possible. For example, analysis of the records for a particular SUV model of a particular manufacturer could indicate a weak location on the frame that nearly always deforms in an accident at any speed. The results of the analysis could be provided to manufacturers or the government or other parties, in some cases for a fee.

The verification information records stored in the local computer at each station and in the central database at the central server can be regularly synchronized so that they contain current records. The verification data accumulated at each of the stations is regularly uploaded as explained earlier. It is also possible to download from the central server to a station, verification records that have been accumulated from other stations. For example, it would be possible to download to all of the stations in the metropolitan New York area, all of the verification records accumulated from all of the New York stations. This would increase the chances that, when a particular vehicle is brought to one of the New York stations, the station will already contain information about the vehicle and other inspections.

The task of the operator of the verification inspection system is simplified by the use of voice prompted instructions for setting up and taking the measurements. The voice prompts can take the form of .WAV files that are played to the operator by the local computer at successive stages of the setup and measurement process. The voiced prompts can include instructions to the operator and comments to the operator about the progress of the system in performing a step of the process. The voiced prompts can also include the pass-fail results of the verification inspection.

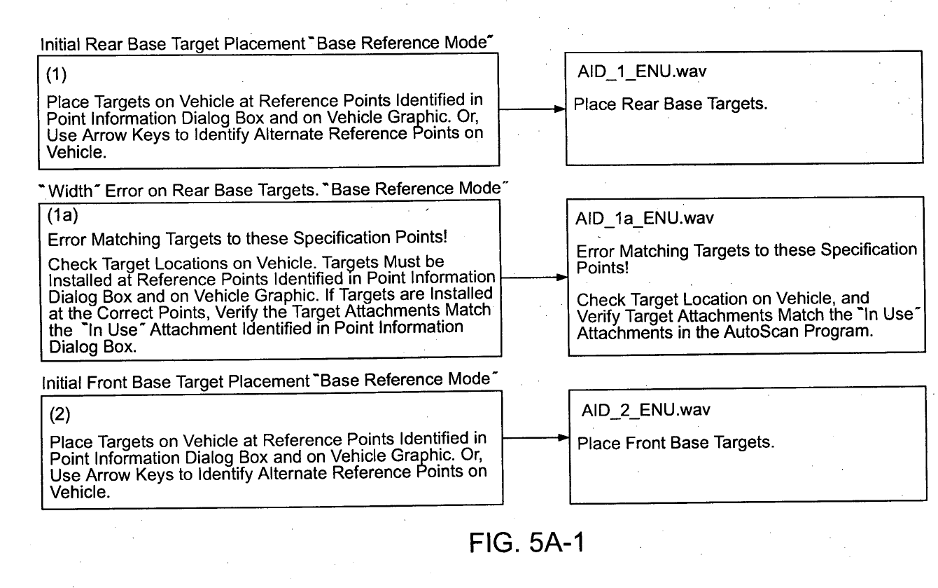

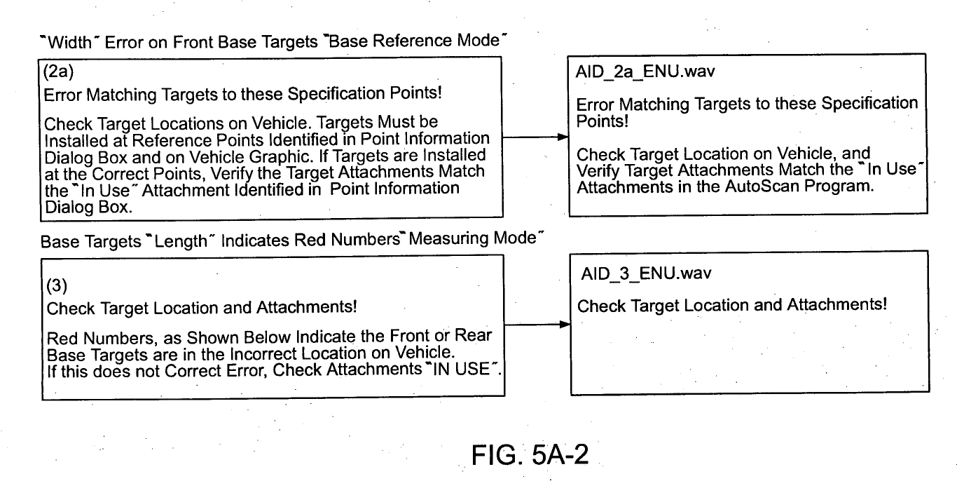

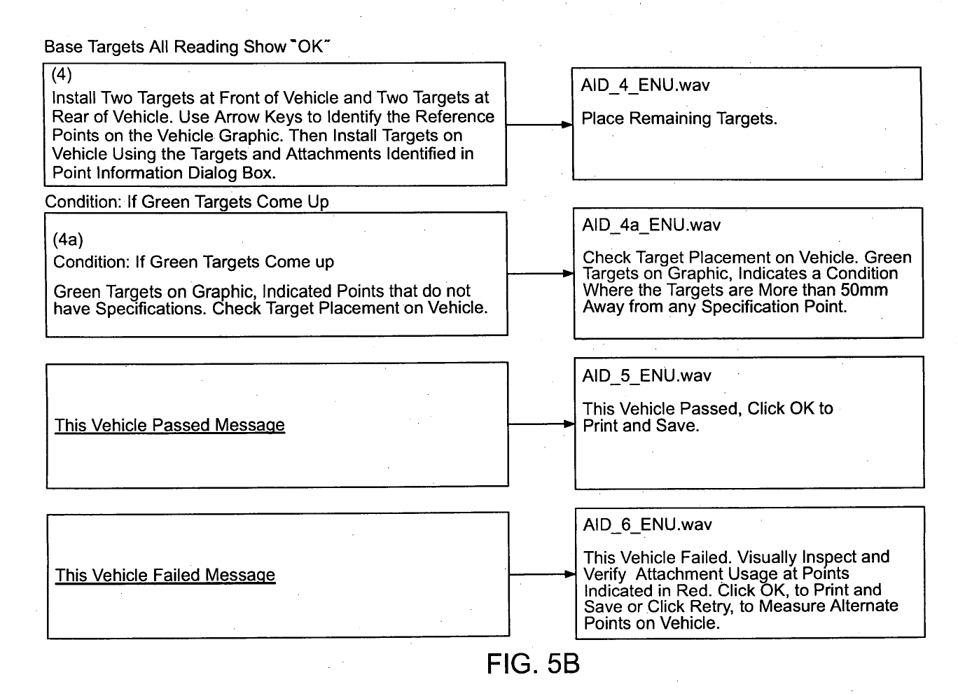

For example, the following voiced prompts could be used: “Place Rear Base Targets”, “Error matching Targets to these specification Points”, “Check Target location on Vehicle, and Verify Target Attachments match the “In Use” attachments in the AutoScan program,” “Place Front Base Targets”, “Error matching Targets to these specification Points”, “Check Target location on Vehicle, and Verify Target Attachments match the “In Use” attachments in the AutoScan program”, “Check Target Location and Attachments”, “Place Remaining Targets”, “Check Target placement on Vehicle. Green Targets on Graphic, indicates a condition where the targets are more than 50 mm away from any specification point”, “This Vehicle Passed, Click OK to Print and Save”, “This Vehicle Failed. Visually inspect and verify attachment usage at points indicated in Red. Click OK, to Print and Save or Click Retry, to measure alternate points on Vehicle.” The relationship between the state of the verification inspection process and the voiced prompts is illustrated in FIGS. 5A and 5B.

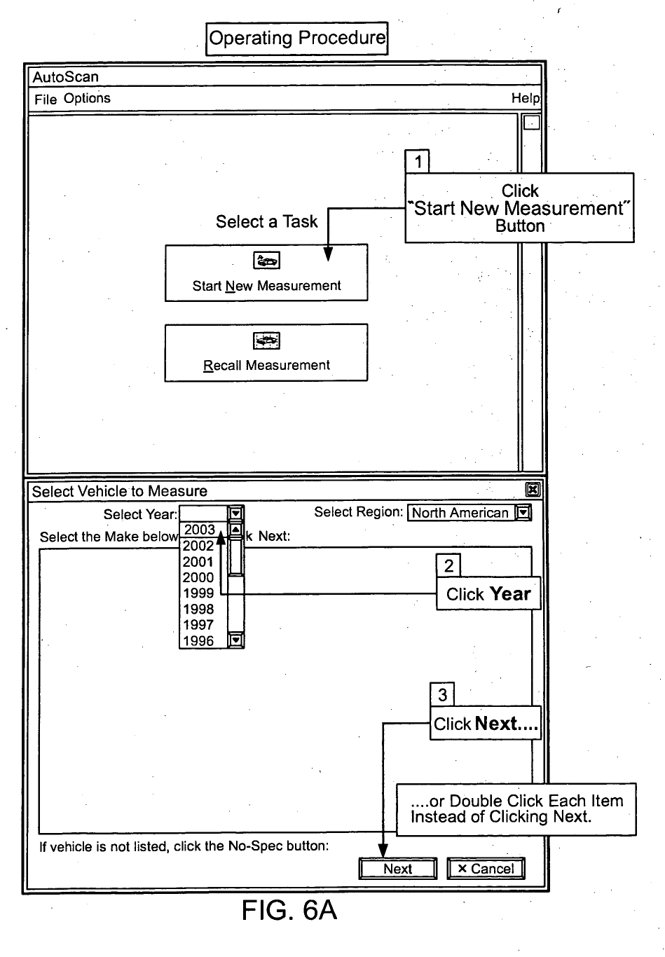

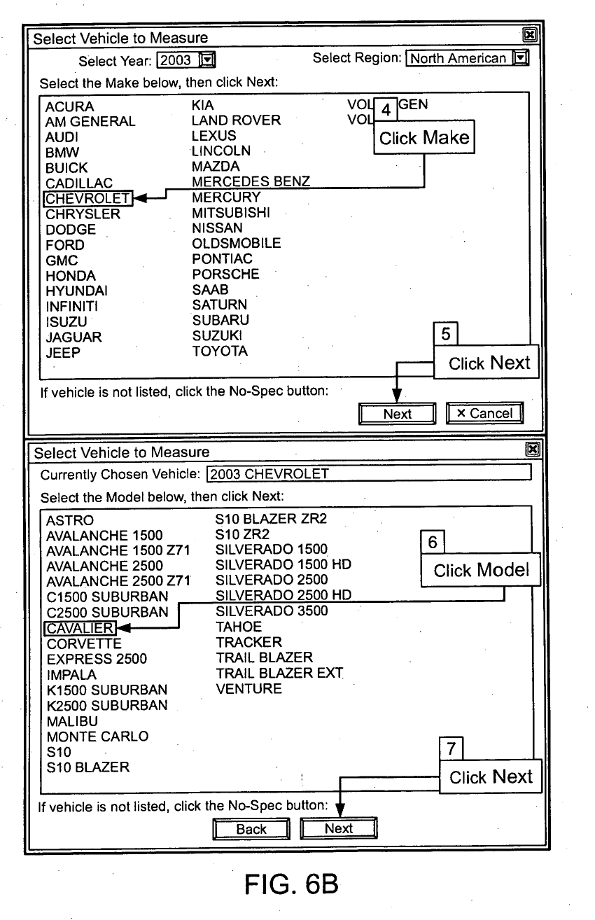

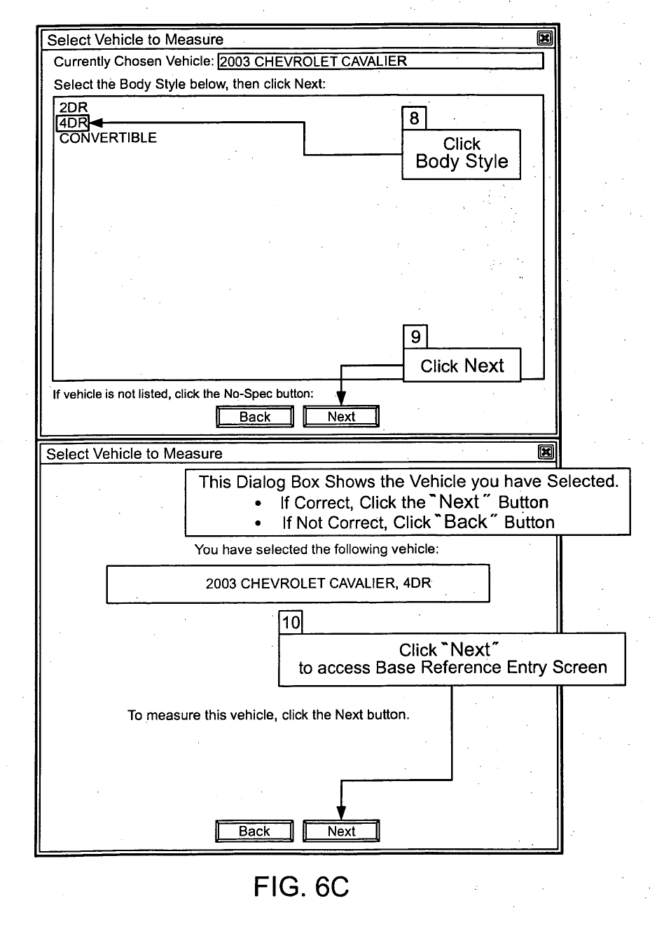

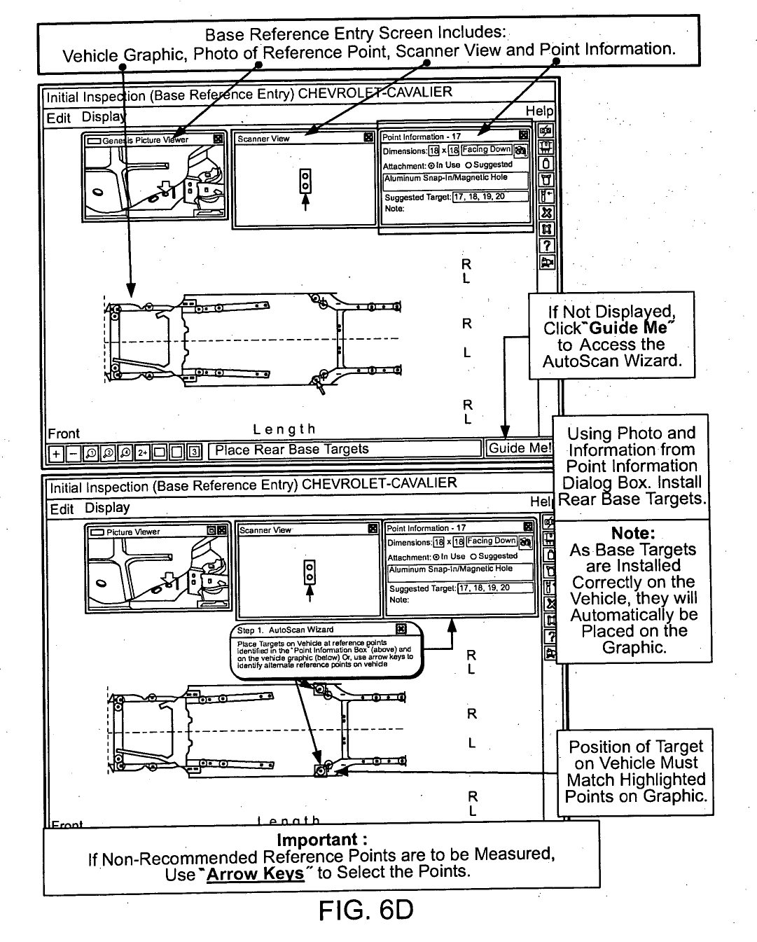

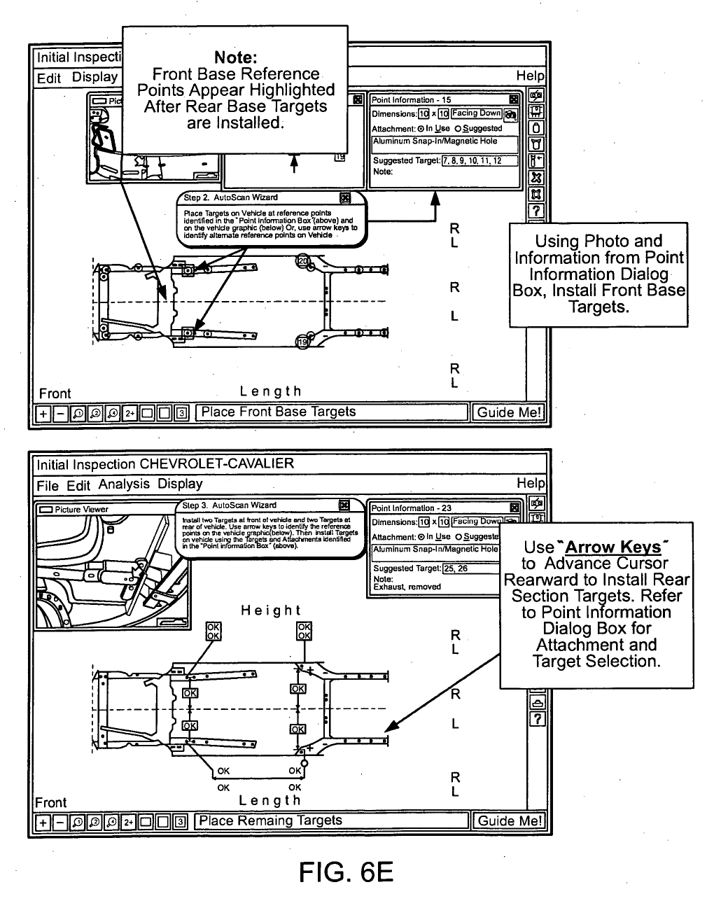

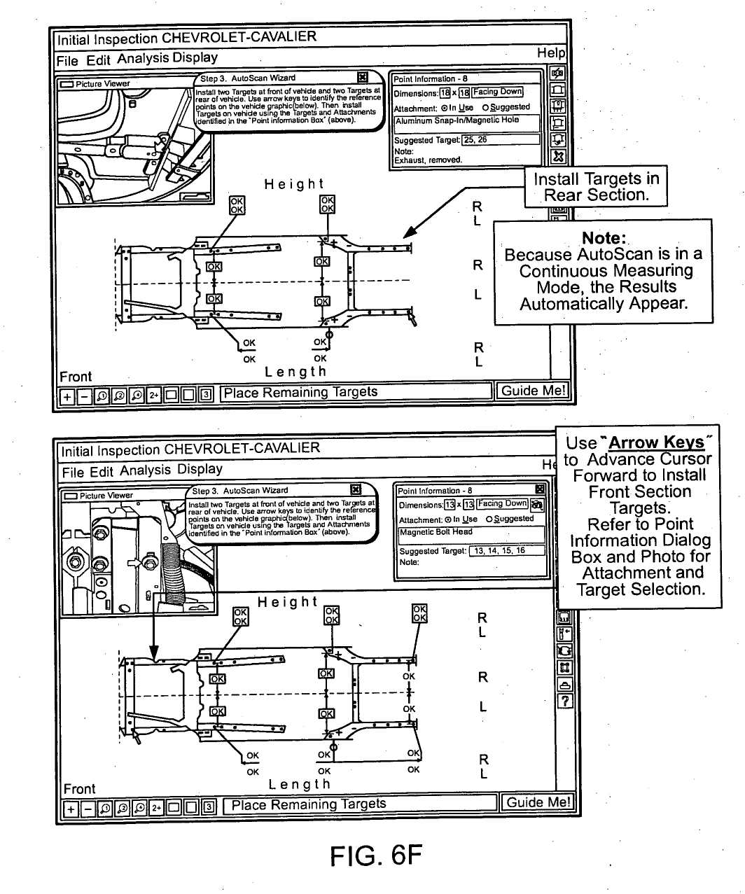

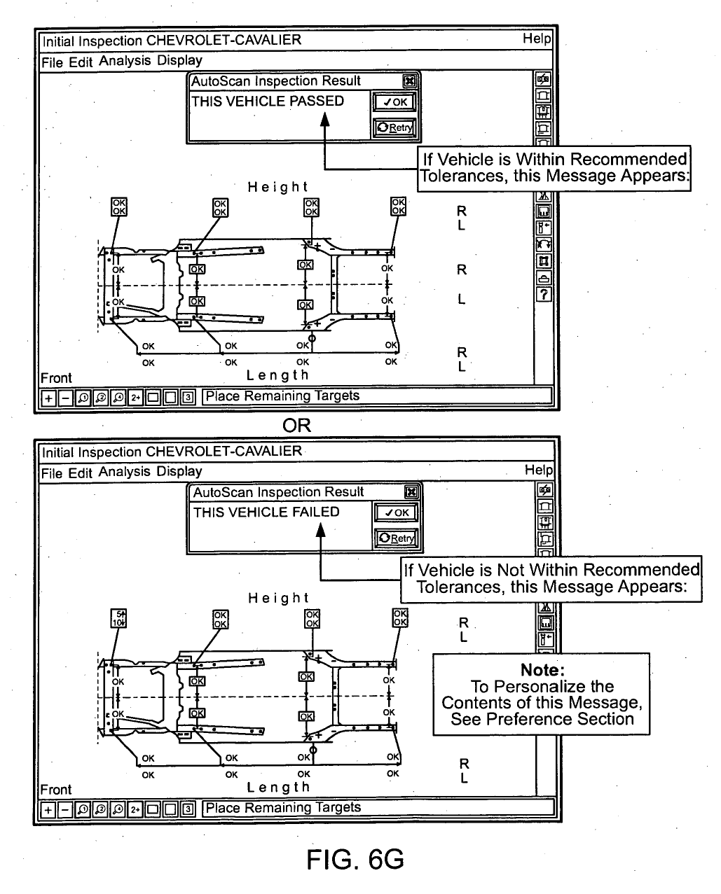

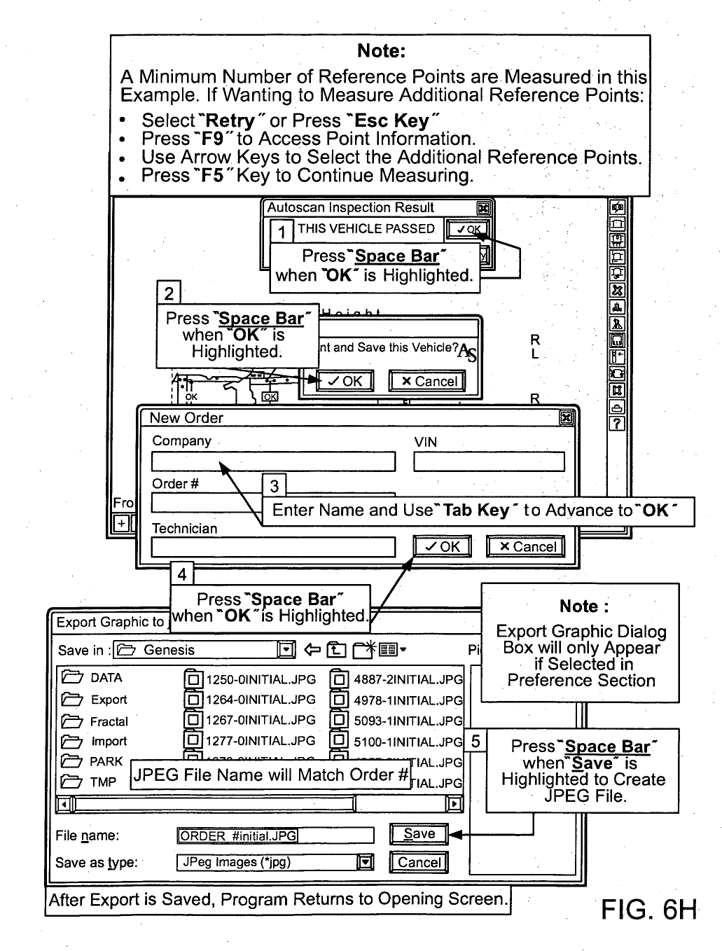

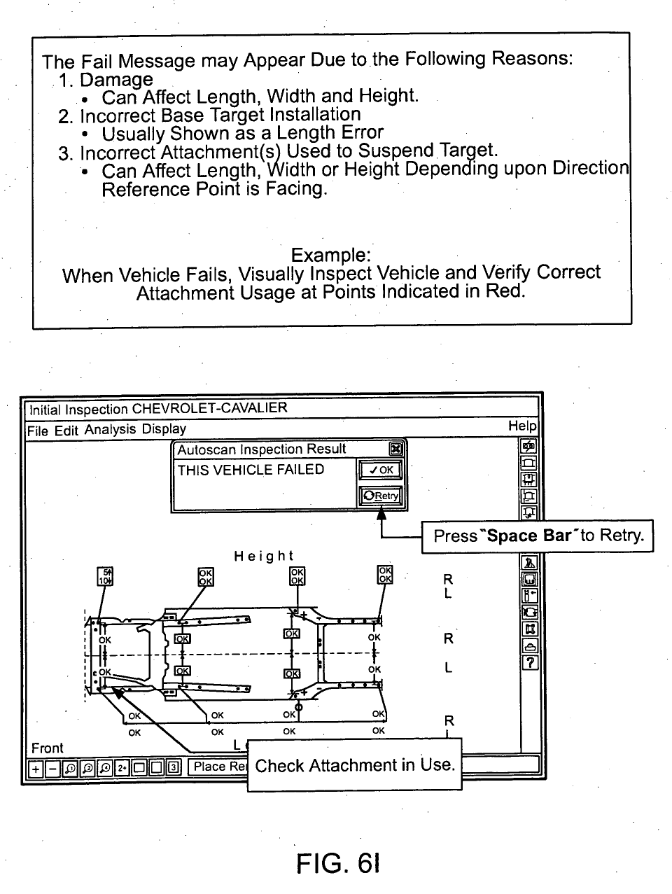

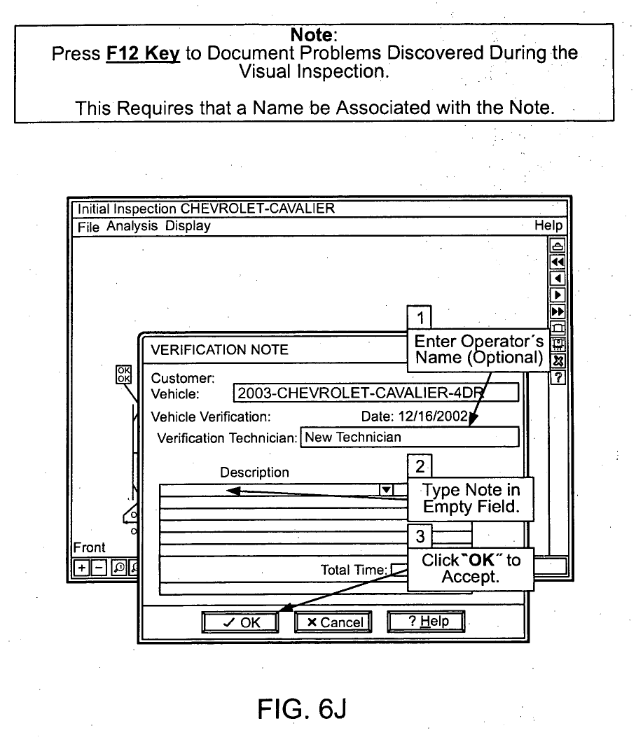

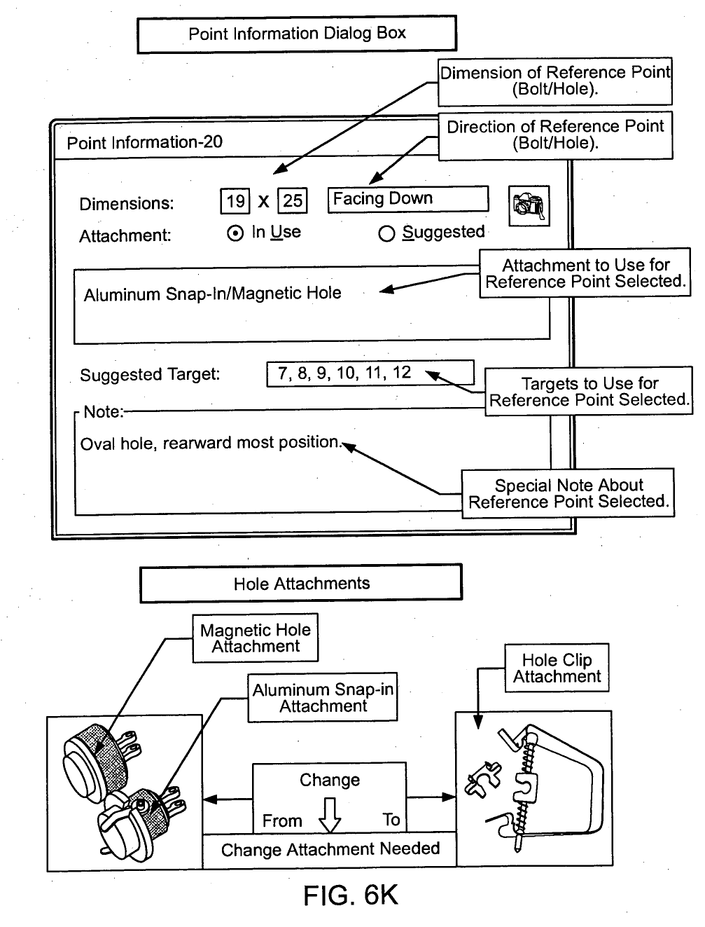

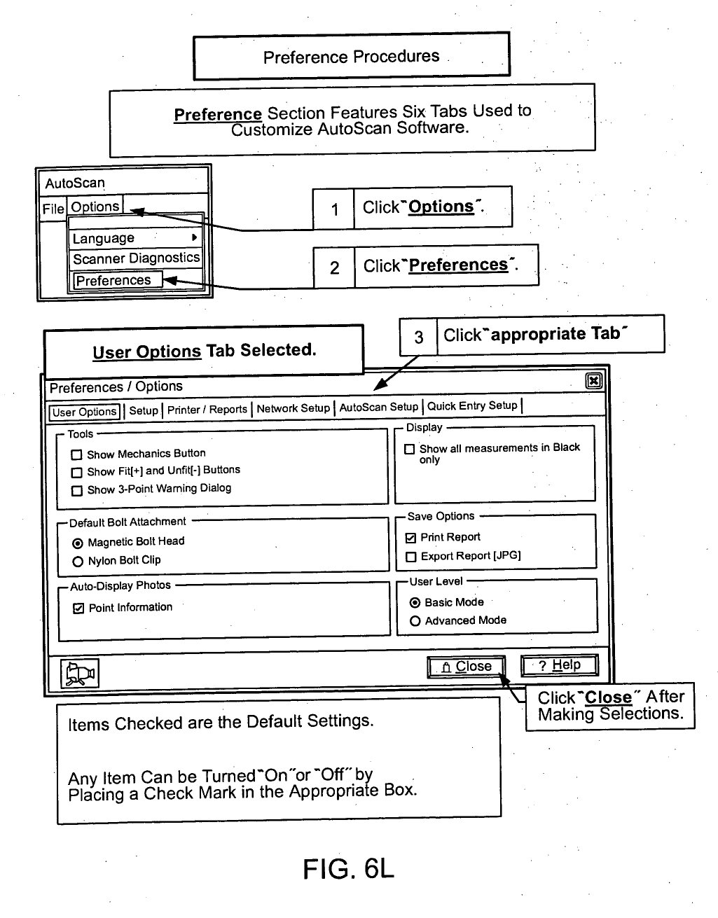

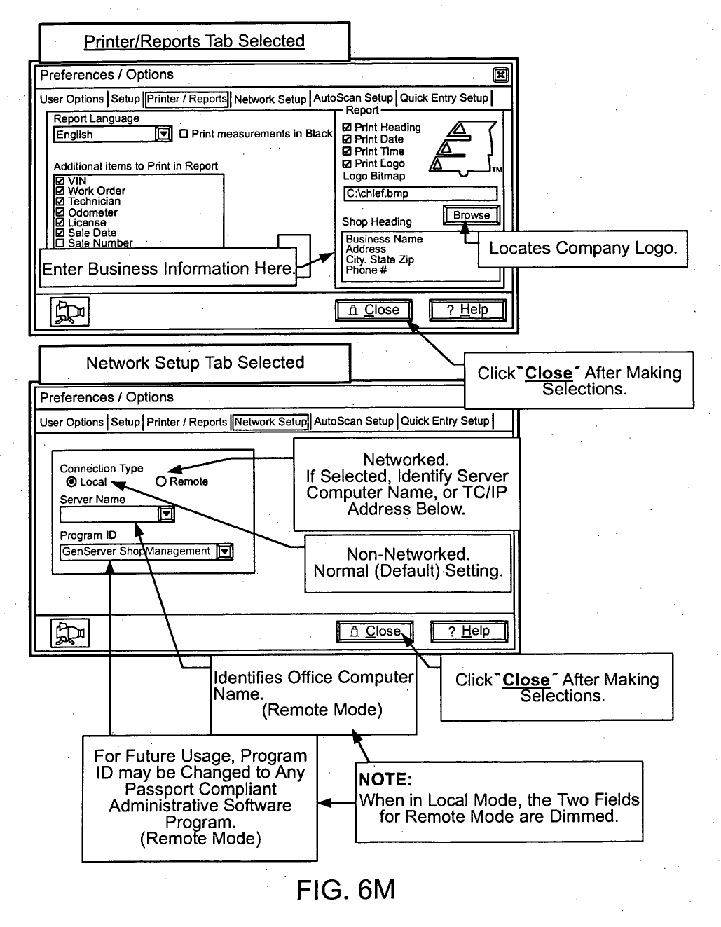

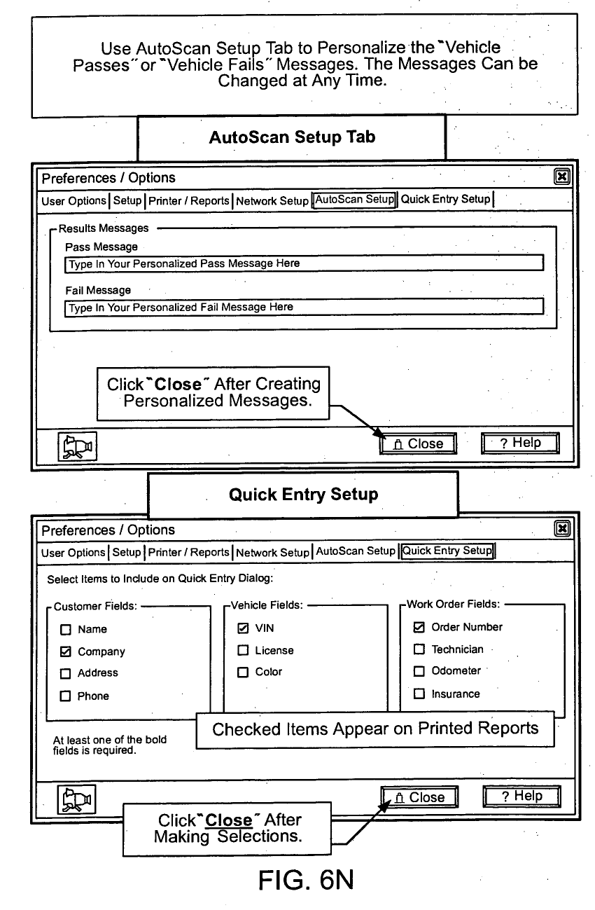

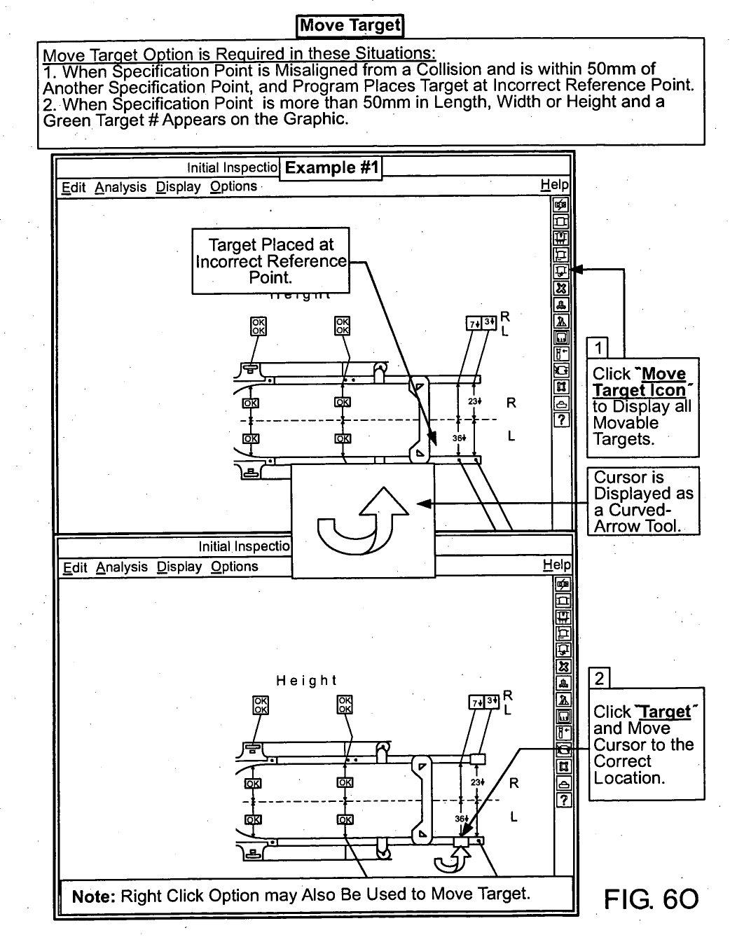

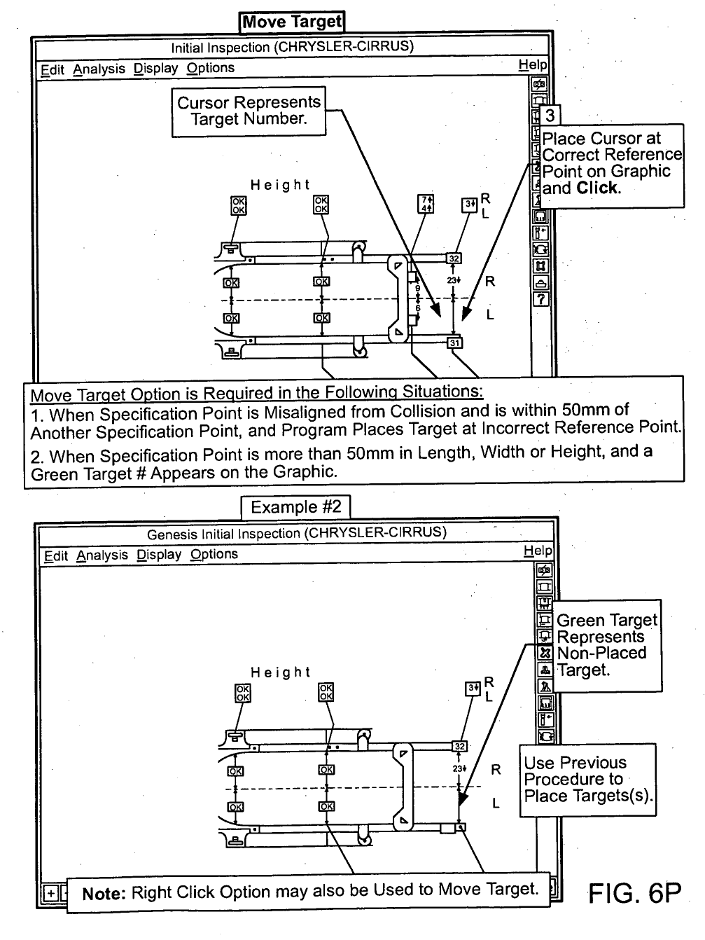

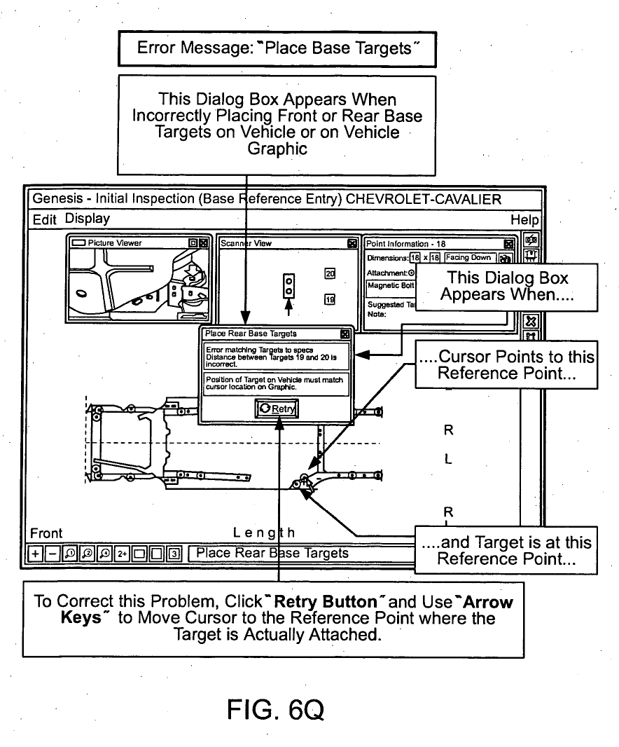

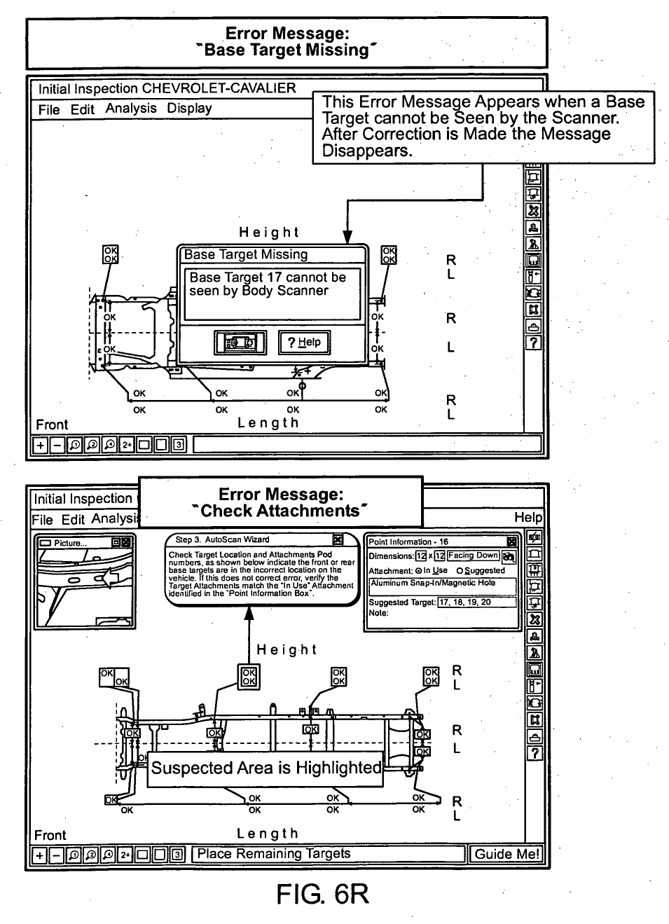

Interactive screens are also provided by the system to enable the operator to setup the system and make the measurements. Aspects of the user interface are shown in FIGS. 6A through 6R.

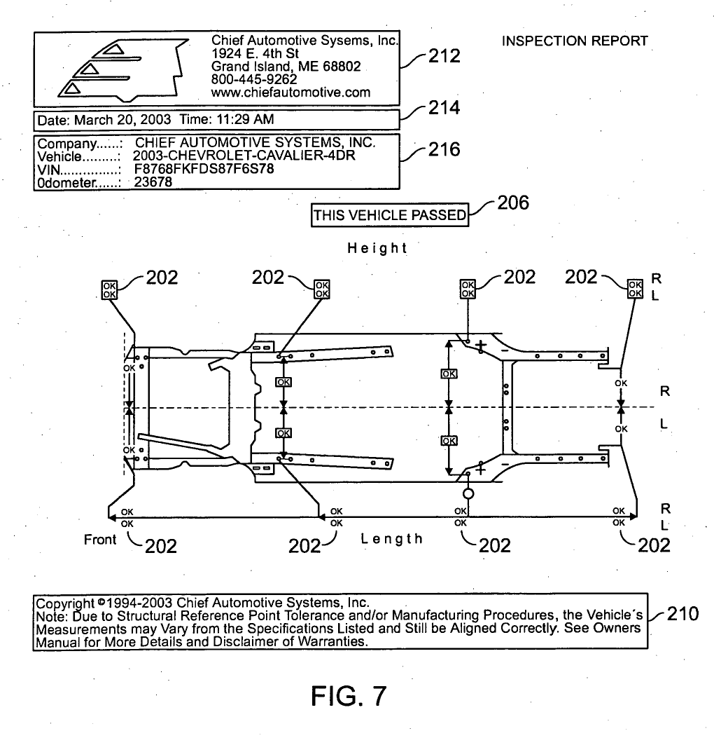

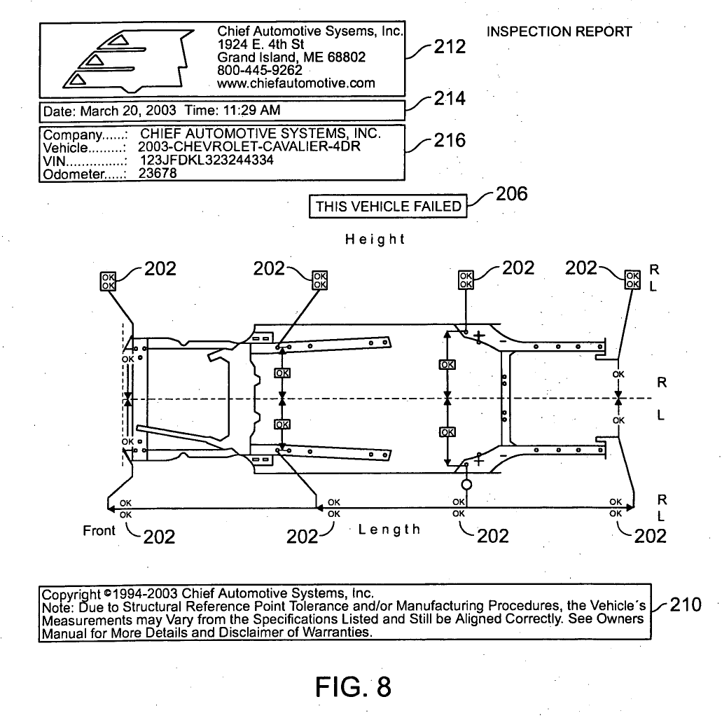

FIGS. 7 and 8 are examples of inspection reports that may be displayed to the operator and printed for delivery to the customer. The inspection report provides proof of the frame condition. A simple pass/fail indication 206 is included in the certificate. In FIG. 7, the vehicle has passed, while in FIG. 8 the vehicle has failed. A schematic picture of the frame 208 including the locations of sensors 209 provides a visual aid the user for understanding measurement results. The results of each measurement are clearly displayed 202. If the measurement is within tolerance of the specification an “OK” designation is shown. Otherwise, the measurement data will be shown indicating whether the measured value is above or below the specified value. The certificate also contains vehicle data 216 and measurement time 214. Additionally, the certificate may display a selected business logo 212 and a copyright notice 210. In some implementations, for example, in the case of a system being used by an auto auction, the OK designations can be replaced by or supplemented with the measurement values.

The information that is acquired by the various stations, communicated among the stations, the server, and the user, and stored in the databases is expressed in records each containing specific fields. In general, the verification records stored in the local station or in the central server would contain, among other items: the date of the inspection, the zip code or other indication of the location of the station, the name of the station, the VIN of the vehicle, the odometer reading, the model year, the make, the style, the model, the locations of the measurement points (e.g., eight points, four on either side of center, two of the four to the front and two of the four to the rear), and pass-fail measurement information for each of the points. In addition the stored data could include an identifier of the scanner used, the version of the specification data used for comparison, the tolerances used in the comparison, black box recorder information, and notes taken by the operator about the accident history of the vehicle.

The specification data for vehicles is also maintained in a database in which the records include, for each make, model, and style of vehicle, an identification of the points at which measurements are to be made, and data identification the locations of those points. The point data is maintained as point pairs. Each point pair may be defined in terms of type of point (bolt, stud, hole, etc.). Graphical information is also stored that enables the point positions to be displayed graphically or printed.

The steps used in measuring a vehicle and generating the data may, in one example, be the following:

1. Locate two of the key positions that are toward the rear of the center section of the vehicle, the two key positions being at corresponding locations on opposite sides of the vehicle (e.g., passenger side and drive side). Using system recommendations, place attachments and targets at those two key positions. The scanner and computer will determine the distance between the targets at the two corresponding key positions. If the distance from the original specification is greater than 50 mm, the system will display an error message. Otherwise proceed to step 2.

2. Locate two of the key positions that are toward the front of the center section of the vehicle, the two key positions being at corresponding locations on opposite sides of the vehicle. Using system recommendations, place attachments and targets at those two key positions. The scanner and computer will determine the distance between the targets at the two corresponding key positions. If the distance from the original specification is greater than 50 mm, the system will display an error message. Otherwise proceed to step 3.

3. Using the four base targets previously placed, the system determines a three-dimensional datum plane for the vehicle. In effect, the system transforms the raw data derived from the four targets so that they lie on a so-called datum plane (because the vehicle may not be held in a level position on the two-post lift, the raw data points may not be on the datum plane and the transformation transforms them to such a plane. Utilizing the transformed data on the datum plane, the system determines if each measured point is within 8 mm of the specification and within 6 mm of the corresponding measured point on the other side of the vehicle.

4. Place four remaining targets at two corresponding key locations at the rear of the vehicle and two corresponding key locations at the front of the vehicle, according to the system recommendations.

5. Using the pass-fail criteria (tolerances) of 8 mm to a single point and 6 mm symmetrical (between corresponding points on opposite sides of the vehicle) the system will evaluate the vehicle. If all placements (the targets at the key positions) are within tolerances, the vehicle will pass. If any placement is outside the tolerance, the vehicle will fail.

The computer 26 at each station runs software (which can be programmed using a variety of software platforms) that includes routines that enable it to do a variety of tasks. The software accepts raw data from the scanner representing the raw measurements of the key positions on the frame. The raw data is processed to produce measurement data. The measurement data is compared to the stored specification data for the vehicle model being measured, with reference to the tolerances that have been pre-set. A pass-fail conclusion is reached about the frame of the vehicle.

The software manages a graphical and audible user interface for the operator of the system. The user interface provides instructions and guidance to the user on setup of the system, and on taking measurements, enables the operator to manage the processing of the measurement data, and receives preference and other control information from the operator, provides voiced and displayed prompts and guidance. The operator may enter information about the vehicle being measured, including the make, model, style, and VIN.

The software also manages the interface with the verification database and the specification database that reside on the local computer. The software assembles the entered information about the vehicle and the measurement data and stored it in the database. The software also enables the operator to retrieve, update, and delete records from the database.

The software also manages communication between the local computer and the server. It receives and stores in the local database, specification records and verification records received from central server. It also manages the uploading of verification records from the local computer to the central server. In the case of a system that is being used to generate new specification information by measuring new units of new models of vehicles, the software also manages the uploading of the specification information to the central server.

Software running on the central server provides similar functions in managing the user interface and managing the interaction with the server databases. In addition, the software in the central server manages the generation and delivery of verification information to users either directly or indirectly through third-party suppliers. The server software also manage a billing system, synchronizes local databases with the central database and vice versa, performs statistical analysis of verification records, receives and assembles specification data for use in the specification database, provides a website and serves pages to the website.

Although certain examples and implementations have been described, other embodiments are also within the scope of the following claims.

1. A machine-based method comprising
maintaining data indicative of an aspect of structural integrity of identifiable vehicles after the vehicles have been manufactured, and
distributing selected portions of the data to customers in response to requests.

2. The method of claim 1 in which the aspect of structural integrity comprises frame straightness.

3. The method of claim 1 in which the aspect of structural integrity comprises involvement in collisions.

4. The method of claim 1 in which the vehicles are identified by vehicle identification numbers.

5. The method of claim 4 in which the requests of at least some of the customers are received through a website or email.

6. The method of claim 1 also including arranging for payment by the customers for the selected portions of the data.

7. The method of claim 1 in which the data indicative of an aspect of structural integrity comprises data that is acquired by inspection of the vehicles.

8. The method of claim If in which the data is acquired by measuring locations on the vehicle and comparing the measurements to predefined values.

9. The method of claim 1 in which the data is maintained in a central database and distributed through a server.

10. A machine-based method comprising
associating (1) first data indicative of an aspect of structural integrity of an identifiable vehicle as of a first time with (2) second data indicative of the aspect of structural integrity of the identifiable vehicle as of a second time, and
making the associated data available as a history of the aspect of structural integrity of the identifiable vehicle.

11. The method of claim 10 in which the aspect of structural integrity comprises frame straightness.

12. The method of claim 10 in which the aspect of structural integrity is associated with involvement in a collision.

13. The method of claim 10 in which the vehicle is identified by a vehicle identification number.

14. The method of claim 10 in which the history is distributed to a user in response to a request.

15. The method of claim 10 in which the first data and second data indicative of an aspect of structural integrity comprise data that is acquired by inspection of the vehicle.

16. The method of claim 10 in which the first data and the second data is maintained in a central database and distributed by a server.

17. The method of claim 10 in which additional data of the aspect of structural integrity of the identifiable vehicle as of another time is associated with the first data and the second data as part of the history.

18. A machine-based method comprising
receiving data indicative of an aspect of structural integrity of identifiable vehicles after the vehicles have been manufactured, the data being generated by inspection of the vehicles at multiple locations.

19. The method of claim 18 including updating the data from time to time based on additional inspections of vehicles.

20. The method of claim 18 in which at least some of the data is received from locations at which vehicles have been inspected.

21. The method of claim 18 in which the aspect of structural integrity comprises frame straightness.

22. The method of claim 18 in which the aspect of structural integrity is associated with involvement in collisions.

23. The method of claim 18 in which the vehicles are identified by vehicle identification numbers.

24. The method of claim 18 in which data for an identified vehicle is distributed to a customer in response to a request.

25. The method of claim 24 in which the request of the customer is received through a website or email.

26. The method of claim 24 in which the data is maintained in a database that associates vehicle identification numbers with received data for the corresponding vehicles.

27. The method of claim 24 also including sending to the multiple locations data indicative of expected structural integrity of the vehicles based on information about original specifications for the vehicles.

28. A machine-based method comprising
by inspection, acquiring data indicative of aspects of structural integrity of a vehicle, and
based on the data and information about an expected structural integrity of the vehicle, indicating one of either (1) that it conforms to the expected structural integrity or (2) that it does not conform to the expected structural integrity.

29. The method of claim 28 in which the aspect of structural integrity comprises frame straightness.

30. The method of claim 28 in which the aspect of structural integrity is associated with involvement in a collision.

31. The method of claim 28 in which the vehicle is identified by a vehicle identification number.

32. The method of claim 28 in which the indication of conformity or non-conformity is provided to a user upon request.

33. The method of claim 28 also including arranging for payment by the user.

34. The method of claim 28 in which the data indicative of an aspect of structural integrity comprises data that is acquired by inspection of the vehicles.

35. The method of claim 28 in which the data and information are maintained at the location where the vehicle is inspected.

36. A machine-based method comprising
providing to a user upon request a confirmation of whether or not an aspect of structural integrity of an identifiable vehicle complies with an expected structural integrity of the vehicle.

37. The method of claim 36 in which the aspect of structural integrity comprises frame straightness.

38. The method of claim 36 in which the aspect of structural integrity comprises involvement in a collision.

39. The method of claim 36 in which the vehicle is identified by a vehicle identification number.

40. The method of claim 36 also including arranging for payment by the user.

41. The method of claim 36 in which the confirmation is based on data that is acquired by inspection of the vehicle.

42. The method of claim 36 in which the confirmation is provided through a website or by email.

43. The method of claim 36 in which the confirmation is based on comparison with predefined values for structural integrity.

44. A machine-based method comprising
maintaining a central database that associates each of a set of vehicle identification numbers of vehicles with data indicative of an aspect of structural integrity of the vehicle, the data being derived from at least one inspection of the vehicle, the inspections of at least some of the different vehicles having been done at different locations.

45. The method of claim 44 in which the aspect of structural integrity comprises frame straightness.

46. The method of claim 44 in which the aspect of structural integrity is associated with involvement in collisions.

47. The method of claim 44 in which the data indicative of an aspect of structural integrity comprises data that is acquired by inspection of the vehicles.

48. The method of claim 44 in which the data is acquired by measuring locations on the vehicle and comparing the measurements to predefined values.

49. The method of claim 44 also including distributing the data through a server.

50. A machine-based method comprising
acquiring data indicative of an aspect of structural integrity of a vehicle at an inspection facility, and
communicating the data from a local device associated with the inspection facility to a device associated with a central database that includes structural integrity data for other vehicles acquired at other inspection facilities.

51. The method of claim 50 in which the aspect of structural integrity comprises frame straightness.

52. The method of claim 50 in which the aspect of structural integrity comprises involvement in collisions.

53. The method of claim 50 in which the vehicles are identified by vehicle identification numbers.

54. The method of claim 50 in which the data is acquired by measuring locations on the vehicle and comparing the measurements to predefined values.

55. The method of claim 50 in which the data is distributed from the database through a server to recipients.

56. A machine-based method comprising
acquiring data indicative of an aspect of structural integrity of vehicles at an inspection facility,
communicating the data from a local device associated with the inspection facility to a central database,
maintaining a copy of a portion of the central database on the local device, and
synchronizing the portion of the database on the local device with the central database.

57. The method of claim 56 in which the aspect of structural integrity comprises frame straightness.

58. The method of claim 56 in which the aspect of structural integrity is associated with involvement in collisions.

59. The method of claim 56 in which the vehicles are identified by vehicle identification numbers.

60. The method of claim 56 in which the data is acquired by measuring locations on the vehicle and comparing the measurements to predefined values.

61. The method of claim 56 in which the synchronizing comprises communicating to the central database information about vehicles that has been acquired at the local device and not previously communicated to the central database.

62. The method of claim 56 in which the synchronizing comprises communicating to the local device information about vehicles that has been acquired otherwise than at the local device.

63. A machine-based method comprising
communicating electronically from a database to an intermediary, for redistribution to users, data that associates vehicle identification numbers of vehicles with data indicative of structural integrity of the vehicles, and
providing updates of the data automatically.

64. The method of claim 63 in which the intermediary comprises an on-line information provider.

65. The method of claim 63 in which the updates are communicated as a continuous stream that contains data not previously communicated.

66. The method of claim 63 in which the updates are communicated as a batch that contains data not previously communicated.

67. The method of claim 63 also including receiving payment for the updates.

68. The method of claim 63 in which the aspect of structural integrity comprises frame straightness.

69. The method of claim 63 in which the aspect of structural integrity is associated with involvement in collisions.

70. A machine-based method comprising
communicating electronically from a database to a party, for use in making a decision about a vehicle, data that associated vehicle identification numbers of vehicles with measured data indicative of structural integrity of the vehicles.

71. The method of claim 70 in which the data is communicated to an individual and the decision comprises whether to buy the vehicle.

72. The method of claim 70 in which the data is communicated to an insurance company and the decision comprises whether to pay a claim for damages to the vehicle.

73. The method of claim 70 in which the data is communicated to a financing entity and the decision comprises whether to lend money secured by the vehicle.

74. The method of claim 70 in which the aspect of structural integrity comprises frame straightness.

75. The method of claim 70 in which the aspect of structural integrity comprises involvement in collisions.

76. The method of claim 70 in which the vehicles are identified by vehicle identification numbers.

77. The method of claim 70 in which the data is acquired by measuring locations on the vehicles and comparing the measurements to predefined values.

78. The method of claim 70 in which the data is maintained in a central database and distributed through a server.

79. A machine-based method comprising
making available to a user of a website, information about vehicles that are identified by vehicle identification numbers, and
enabling the user to access structural integrity information for a vehicle selected by vehicle identification number.

80. The method of claim 79 also including making other kinds of information about the vehicles available to the user on the website.

81. The method of claim 80 in which the other kinds of information comprise collision reports for the vehicles.

82. The method of claim 80 in which the aspect of structural integrity comprises frame straightness.

83. The method of claim 80 also including arranging for payment by the customers for access to the information.

84. The method of claim 80 in which the data indicative of an aspect of structural integrity comprises data that is acquired by inspection of the vehicles.

85. The method of claim 80 in which the data is acquired by measuring locations on the vehicles and comparing the measurements to predefined values.

86. The method of claim 80 in which the data is maintained in a central database and distributed through a server.

87. A machine-based method comprising
enabling a user to set up equipment to acquire data indicative of an aspect of structural integrity of a vehicle, and
providing voiced machine prompts to guide the user in correctly setting up the equipment.

88. The method of claim 87 in which the voiced machine prompts identify locations to be measured on the vehicle.

89. The method of claim 87 in which the voiced machine prompts confirm whether the locations have been correctly set.

90. The method of claim 87 in which the voiced machine prompts are provided from a device that also controls acquisition of the data by the equipment.

91. The method of claim 87 in which the aspect of structural integrity of the vehicle includes frame straightness.

92. The method of claim 87 in which the aspect of structural integrity of the vehicle includes occurrence of a collision.

93. A machine-based method comprising
analyzing original equipment manufacturer's engineering drawings with respect to an aspect of structural integrity of a vehicle, and
generating a specification for locations at which to measure the aspect of structural integrity for an actual vehicle built according to the engineering drawings.

94. The method of claim 93 in which the aspect of structural integrity comprises frame straightness.

95. The method of claim 93 in which the locations are locations on a frame of the vehicle.

96. A machine-based method comprising
analyzing data indicative of an aspect of structural integrity of vehicles manufactured by a particular manufacturer, and
identifying possible flaws in vehicle design based on results of the analysis.

97. The method of claim 96 in which the data is associated with units of a vehicle of a particular model.

98. The method of claim 96 in which the data is derived by inspection of the vehicles after they have been manufactured and placed into use.

99. The method of claim 96 also including making the flaws available to manufacturers.

100. The method of claim 96 in which the aspect of structural integrity comprises frame straightness.

101. A database comprising
a set of vehicle identifiers, and
associated with each of the vehicle identifiers, data indicative of an aspect of structural integrity of the vehicle.

102. The database of claim 101 in which the vehicle identifiers comprise vehicle identification numbers.

103. The database of claim 101 in which the data indicative of an aspect of structural integrity of the vehicle includes data acquired by measuring locations on the vehicle.

104. The database of claim 101 also comprising
data indicative of expected structural integrity of the vehicle based on information of the manufacturer of the vehicle.

105. The database of claim 101 in which the data comprises frame straightness data.

106. The database of claim 101 in which the data comprises collision data.

107. A machine-based method comprising
receiving frame straightness data from multiple locations at a central database, the frame straightness data having been produced by inspecting automobiles for frame straightness at the multiple locations,
including in the central database information related to comparisons of the straightness data with reference straightness information derived from specification data developed from manufacturers of the automobiles,
providing the straightness data or the comparison information to users upon request, and
receiving payment from the users for the data or information.

108. Apparatus comprising
a port to receive structural integrity data from an inspection device that inspects an automobile for structural integrity, and
a processing device configured to communicate the structural integrity data to a location in which a central database of structural integrity information and related vehicle identification information is maintained.

109. The apparatus of claim 108 also including
a user interface associated with the processing device and that enables a user to control the inspection device.

110. The apparatus of claim 109 also including
a voice synthesizer to provide voice instructions to the user for setting up and using the inspection device.

111. The apparatus of claim 108 also including a storage device to hold information about expected structural integrities of models of vehicles, and in which the processing device is also configured to compare the inspected structural integrity information to the expected structural integrity information.

112. A machine-based method comprising
receiving from a data recorder associated with a vehicle, data obtained at the time of an occurrence of an incident that may have altered a structural integrity of the vehicle,
after the incident, receiving measurements of the structural integrity of the vehicle, and
analyzing a relationship between the incident data and the measurements.

113. The method of claim 112 in which the incident data includes at least one of vehicle speed, engine RPM, and brake application, throttle position, seatbelt state, airbag state, airbag warning light state, time from impact to airbag deployment, and maximum change in velocity for a near deployment incident.

114. The method of claim 112 in which the incident comprises an accident.

115. The method of claim 112 in which the measurements include measurements of a frame of the vehicle.

116. The method of claim 112 also including
receiving incident data and structural integrity measurements for multiple vehicles and multiple incidents, and
statistically analyzing the data and structural integrity measurements.

117. The method of claim 112 in which the recorder comprises a recorder associated with an air-bag system.

118. A verification inspection workstation comprising
a housing,
a computer,
a monitor, and
software configured to enable the computer to acquire measured information about the structural integrity of a vehicle and to forward the information electronically to a central server at which information about the structural integrity of other vehicles is stored.

119. The workstation of FIG. 118 also including a laser scanner, targets, and attachments.

120. A server comprising
a computer, and
software configured to enable the computer to maintain measured information, acquired at multiple remote locations, about the structural integrity of vehicles and to distribute the information to users upon request.
